(19) United States
(12) Patent Application Publication
(10) Pub. No.: US 2010/0292887 A1
(43) Pub. Date: Nov. 18, 2010

(54) METHOD AND SYSTEM FOR CONTROLLING SAFETY MEANS FOR A VEHICLE

(76) Inventors: Jens Becker, Stuttgart (DE); Thomas Lich, Schwaikheim (DE); Alfons Doerr, Stuttgart (DE); Josef Kolatschek, Weil Der Stadt (DE); Marcus Hiemer, Kehlen (DE)

Correspondence Address: KENYON & KENYON LLP, ONE BROADWAY, NEW YORK, NY, 10004, US

(21) Appl. No.: 12/734,768

(22) PCT Filed: Oct. 23, 2008
(86) PCT No.: PCT/EP2008/064331

§ 371 Date: Aug. 2, 2010

(30) Foreign Application Priority Data
Dec. 10, 2007 (DE) 10 2007 059 414.5

(51) Int. Cl. B60R 21/0132

(52) U.S. Cl. 701/29

(57) ABSTRACT

In a method and a system for controlling a safety system for a vehicle, a sensor suite is provided to generate at least one yaw-acceleration signal. An evaluation circuit is used to sample the at least one yaw-acceleration signal with a sampling time of less than 10 ms, and to generate a control signal as a function of the at least one sampled yaw-acceleration signal.

### BACKGROUND OF THE INVENTION

1. Field of the Invention

The present invention relates to a method for controlling a safety system for a vehicle and a corresponding system.

2. Description of Related Art

Published German patent application document DE 101 49 112 A1 has already described a method for generating a triggering decision for a restraint system, soil trips being dealt with in particular. Soil trips are situations in which following a skidding event, the vehicle slips sideways and then ends up on a subgrade having a high coefficient of friction, for example, the unpaved subgrade alongside a roadway. The triggering decision is determined as a function of vehicle dynamics data, a sideslip angle in conjunction with a lateral vehicle velocity and a vehicle tilting motion being used as the vehicle dynamics data. The triggering decision is then generated by suitable threshold-value comparison.

According to published international patent application WO-2005/030536 A1, a method is already known for generating a triggering decision for a restraint system, especially in the case of rollover events. In that case, the triggering decision is determined as a function of vehicle dynamics data, the lateral acceleration and the yaw rate about the longitudinal vehicle axis being used as vehicle dynamics data.

Published German patent application document DE 10 2004 021 174 A1 has already described a method for generating a triggering decision for safety-related components of a vehicle, the safety system to be triggered being activated preventively. In that case, the control takes place as a function of at least one threshold value that is predefined, adaptable and characterizes a vehicle dynamic critical for driving safety, in such a way that the threshold value is coupled to the performance required on the part of the driver. The variables regarding vehicle dynamics indicated in that context are of sensors from the ABS-control device such as wheel-speed sensors, a yaw-rate sensor or a driving-environment sensor. In this manner, a vehicle performance critical with regard to safety is evaluated.

From published German patent application document DE 100 61 040 A1, it is known to control restraint devices as a function of signals from a vehicle dynamics control such as ESP (electronic stability program). In that case, a reversible seat-belt pretensioner is triggered directly as a function of the realization of a situation critical with regard to safety, which is detected by the ESP.

Published international patent application WO-2004/094195 A1 describes a device for controlling restraint systems, the restraint means being controlled as a function of a signal from a vehicle dynamics control. The essential idea cited in that case is that the signal from the vehicle dynamics control is used to influence at least one threshold value in a threshold-value comparison of a signal from a crash sensor.

Published international patent application WO-2005/073735 A1 describes a method which determines rotation information with the aid of signals from distributed linear acceleration sensors. For example, this makes it possible to determine the yaw of a vehicle on the basis of linear acceleration information.

Published German patent application document DE 10 2005 012 119 B4 describes a vehicle-crash analysis device which, in addition to the longitudinal acceleration and lateral acceleration, also uses the yaw acceleration. The essence is the determination of crash parameters after the crash, thus after the triggering decision has been made. The point of impact, the force of impact and the angle of impact are named as specific parameters.

The passenger-protection systems described in the related art have the disadvantage that the torque acting during the development of the crash is not adequately measured.

### BRIEF SUMMARY OF THE INVENTION

In contrast, the method of the present invention and the system of the present invention for controlling safety means for a vehicle having the features delineated in the independent patent claims have the advantage that primarily the yaw acceleration is used to generate the control signal for the safety means. In comparison to the yaw rate, for example, the yaw acceleration surprisingly reveals a great deal of information which cannot be deduced from the yaw rate. With this additional information, an effective protection may be achieved, particularly in the scenario of a consequential crash. For example, a case may be taken into consideration in which there is a first non-triggering crash which is an impact that is so weak that it does not require triggering of passenger-protection means, but induces turning moments about the vertical axis, such that they may give rise to possible dangerous, consequential crashes. This may be taken into consideration effectively by evaluating the yaw acceleration.

Moreover, it is advantageous that sampling of the yaw acceleration is made possible with a high sampling rate or a small sampling period of less than 10 ms. Consequently, latency periods are avoided which, for example, exist when the sensor signals get from a control unit of a vehicle dynamics control, for instance, via a bus, to the airbag control unit. Therefore, a sampling time may be in the range of 1 ms, for example, and thus useful input information is available for the control and algorithmic evaluation of irreversible restraint systems such as airbags.

Overall, therefore, by consideration of the yaw acceleration in the collision case, in addition to the monitoring of the linear vehicle movement, a holistic sensing of this vehicle movement is possible. In particular, real crash scenarios as described above may therefore be recorded in greater detail and classified more clearly accordingly. This volume of information may be used to adapt the overall strategy for the activation of the passenger-protection means or safety means in accordance with the comprehensively recorded development of the crash, and thus to increase the protective action on the whole. Robustness and an increase of reliability in the field may thereby be achieved. Moreover, for example, the crash development of vehicle rollovers may be better predicted, and the triggering demand may be adapted accordingly to the restraint means to be activated.

For instance, in the case of a frontal crash with an angle component, a clear yaw-acceleration signal occurs in an early crash phase, which may be used for the crash discrimination. This shows that, already in standardized crash tests, the crash-classification quality is able to be improved. A crash discrimination is also possible on a yaw-angle/yaw-rate level, and underscores the potential for the differentiation of crash developments with the aid of the most widely varied crash features.

Starting out from the present invention, a markedly better classification of real crash scenarios is achieved, such as multi-crashes, crash-induced rollovers, side collisions with skid case history or non-central frontal crashes against narrow objects. The crash development to be anticipated is better judged in terms of the use of suitable safety means. In addition to controlling the trigger circuits for the passenger-protection means, it is also possible on the basis of the yaw-acceleration signals available, to trigger steering or wheel-selective braking interventions, with whose aid the vehicle is able to be stabilized in the event of mild collisions, and whereby the crash probability and crash severity of secondary collisions may be reduced. In addition, it is conceivable to control a device which, in the case of crashes with small overlap, provides for a clasping of the collision counterparties in order to alleviate the severity of injury to the passengers.

The inclusion of the yaw acceleration makes it possible to provide information not only prior to the crash, but also during the crash, which permits the reconditioning of the algorithm for possible subsequent crashes, and thus improves the handling of multi-crashes; for example, by integrating the yaw rate, a yaw angle is obtained, and thereby an alignment of the vehicle after a primary collision, and thus decisive information for possible secondary events.

It is advantageous, for example, to install the control unit together with the integrated yaw-acceleration sensor suite in the vicinity of the vehicle center of gravity. However, in principle, any other mounting location is also suitable, since the yaw-acceleration signals may be transformed into the center of gravity by suitable mathematical functions.

Based on the classification result, the triggering instant may be influenced via a model of the passenger position and the passenger movement and movement direction. For example, this may take place earlier or later, or else be completely suppressed if the protective action of the safety means no longer exists, for instance, in the case of crashes with small overlap in which a strong rotational movement of the vehicle is induced. In this manner, a possible deflection of the passenger in respect to the front airbag due to the rotation that is occurring may be prevented. At the same time, the side or curtain airbag, more favorable in the case, may be activated in order to protect the head of the passenger from an impact on the A-pillar support. By coordinated activation of suitably laid-out airbags in front of and to the side of the passengers, it is also conceivable to purposefully influence their movement in such a way that maximum protective effect is achieved.

In the present case, the system may be a control unit, for instance, which processes the sensor signals and generates the control signal as a function thereof. Control is understood to be the activation of safety means such as passive restraint devices, e.g., airbags or seat-belt pretensioners or crash-active head restraints, but also active passenger-protection means such as a vehicle dynamics control or braking. Steering interventions are also included in this.

The sensor suite is usually a yaw-rate sensor suite, the yaw-acceleration signal then being generated by a converter. For example, this includes a simple differentiator which is realized using software engineering and/or as hardware. The at least one yaw-acceleration signal indicates the yaw acceleration about the vertical vehicle axis.

The sampling of the yaw acceleration is the sampling which is carried out according to communications engineering in order to acquire a signal. The sampling time is the inverse of the sampling rate. The evaluation circuit, e.g., a microcontroller or another processor may be used for this purpose. All possible realizations in hardware and software are conceivable for the evaluation circuit.

For example, the control signal is a firing current; however, it may also be a data signal that communicates to another control unit, for instance, which suitable means of protection, here a brake, are to be controlled. Therefore, the meaning of this term “control signal” is very broad; for instance, it may also be a plausibility signal.

It is advantageous that a communication interface for transmitting and receiving data is provided for the output of the control signal. Such a communication interface may be implemented in hardware and/or software. For instance, it may take the form of what is referred to as a bus controller or bus transceiver, e.g., for the CAN bus. However, it is possible that the communication interface may also be provided as a point-to-point connection to an external device. Consequently, for example, the control signal may be transmitted as a piece of data to another control unit such as the vehicle dynamics control, for instance, so that the vehicle dynamics control takes measures to stabilize the vehicle for the danger of a secondary or multiple collision. This shows the broadness of the meaning of the term “control signal” which may be not only, but also a firing current, e.g., to activate one or more airbags.

Moreover, it is advantageous that the control signal is used by a control algorithm as a plausibility check or as a threshold-value influence. That is, a control algorithm is provided which, for example, as a function of other sensor signals such as acceleration signals or roll-rate signals, structure-borne-noise signals or air-pressure signals, determines whether, which, and when the passenger-protection means should be controlled as safety means. In this context, the control signal is used as a plausibility check, i.e., as an independent evaluation path, at least with regard to the sensor suite as to whether or not a collision exists. Furthermore, it may be provided for the control signal to influence one or more threshold values in the control algorithm, that is to say, this leads to a sharpening or unsharpening of these threshold values, e.g., when the control signal indicates that a very dangerous situation exists. The threshold values are then lowered so as to permit an early control of the passenger-protection means. In order to realize such an independent triggering path, the control signal may be generated by the evaluation circuit, in doing which, the evaluation circuit does not then also calculate the control algorithm, so as to ensure the independence. For instance, dual-core processors may be used for this purpose. Any potential realization of such an independent triggering path is possible. As said, in the present case, independence with respect to the sensors suffices, so that the plausibility check and the control algorithm may also be calculated on the same processor core.

It is further advantageous that the yaw-acceleration signal or a signal derived from it—this derived signal may be the yaw-acceleration signal—enters into an at least three-dimensional vector, and the control signal is generated as a function of a classification of this at least one three-dimensional vector. A very good classification is achieved by way of an at least three-dimensional vector. This three-dimensional vector has three components, i.e., three features, which were derived from sensor signals, to which the yaw-acceleration signal belongs. For example, derivation means filtering, integration, mean-value generation, multiple integration, etc. In addition to the yaw-acceleration signal, other rotational-movement signals or perhaps acceleration signals or signals derived therefrom may be entered into the vector, as well. The more components the vector has, the more precise the classification is able to be. For example, this classification may be achieved with the aid of a support vector machine, a neural network with Markov models, decision trees, evolutionary algorithms, Gaussian processes or different learning-based classificators. The utilization of an at least three-dimensional classificator is advantageous, since in the universal consideration of vehicle collisions on the vehicle level, the state of motion of the colliding vehicle is described clearly by the three linearly independent state vectors of the longitudinal and lateral movement of the center of gravity as well as the yawing motion, and the best possible classification of the instantaneous crash state is thereby made possible.

It is further advantageous that a non-triggering crash is recognized as a function of the at least one yaw-acceleration signal and at least one further sensor signal, and is evaluated in such a way that the safety means are controlled as a function of the control signal, so that protection against at least one consequential crash is achieved. This describes how the yaw-acceleration signal and a further sensor signal, e.g., an acceleration signal, are used to recognize a non-triggering crash and evaluate the motion which this non-triggering crash induces in the vehicle, in order to protect from consequential collisions.

It is also advantageous that a yaw angle is utilized as the at least one sensor signal. Namely, the yaw angle indicates in what direction the vehicle is then aligned, so that it is thereby probable as to which passenger-protection means must be controlled for the consequential crash. Algorithms for these consequential crashes may also be sharpened as a function of these variables.

Moreover, it is advantageous that at least one of the further sensor signals is evaluated as a function of the control signal. This means that the quality of other signals calculated in the control unit is improved with the aid of the yaw acceleration. For instance, if a rotational motion exists, erroneous signal portions produced by the rotation, e.g., of peripheral acceleration sensors, may then be calculated out.

It is further advantageous that the at least one yaw-acceleration signal is generated in such a way that the at least one yaw-acceleration signal is determined with the aid of a minimum variance method. To that end, for example, what is referred to as the RLS estimator may also be used. Accordingly, the rotational acceleration is derived from the measured rotation-rate signals, and the minimum variance method is used for that. Such a minimum variance estimator avoids the amplification of high-frequency portions of the signal, and thus a sub-optimal determination of the change in the acceleration signal over time. One especially advantageous form of this minimum variance estimator is the “least squares estimator.” This least squares estimator is recursive. This permits savings in run time and storage in a control-unit algorithm. In this context, upon each new estimation, only the last estimated value is corrected in consideration of the statistical properties of the signal, so that the term recursive is thereby explained. This recursive procedure therefore saves on computing power. A recursive least squares method is described in the literature, for example, in U. Kiencke and L. Nielsen: Automotive Control Systems, Springerverlag, second edition, 2004. The minimum variance estimator or the least squares estimator may be implemented in hardware and/or software.

Finally, it is also advantageous that the sensor suite is incorporated in a control unit having the evaluation circuit. This makes it possible to sample the signals of the sensor suite in high frequency. Thus, the high-frequency samplings are achieved with a sampling time of less than 10 ms. However, this further has the advantage that electromagnetic influences with respect to interference are reduced. In addition, it is advantageous that, given the installation of the sensor suite in the airbag control unit, this sensor suite profits from an emergency power supply of the airbag control unit, e.g., by way of stored electrical energy in capacitors. This improves the quality of the yaw-acceleration signals, as well as their reliability.

### BRIEF DESCRIPTION OF THE SEVERAL VIEWS OF THE DRAWING

FIG. 1 shows a block diagram of the system according to the present invention, with connected components.

FIG. 2 shows a typical accident situation.

FIG. 3 shows a signal-course diagram according to the present invention.

FIG. 4 shows a flow chart of the method according to the present invention.

FIG. 5 shows a further signal-course diagram according to the present invention.

FIG. 6 shows a further flow chart of the method according to the present invention.

FIG. 7 shows a further signal-course diagram according to the present invention.

FIG. 8 shows an example signal-course diagram illustrating example sensor signals go into the control method of the present invention.

### DETAILED DESCRIPTION OF THE INVENTION

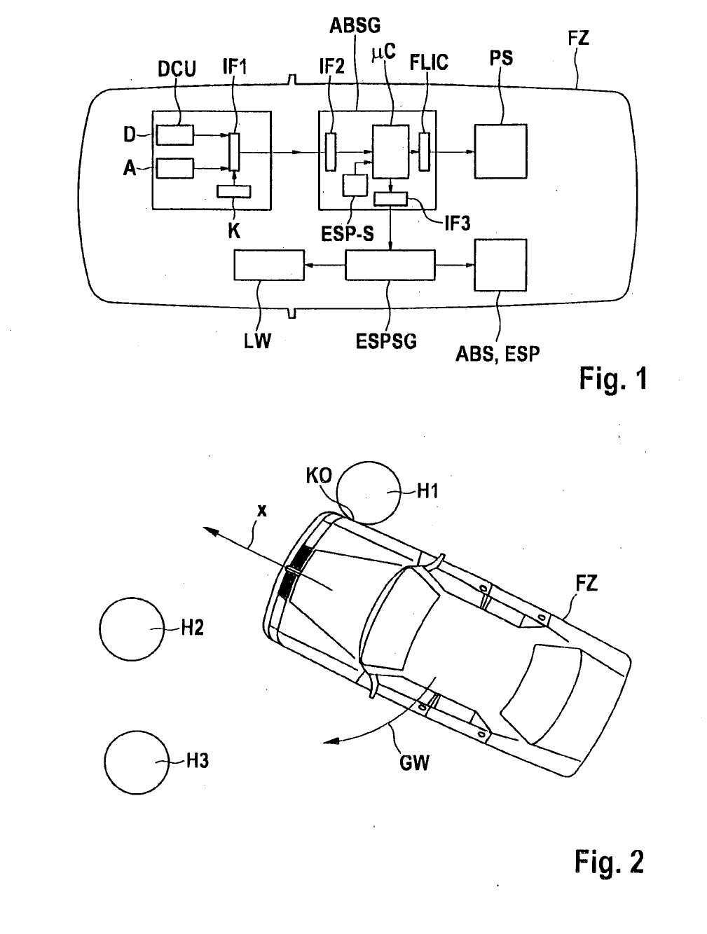

FIG. 1 shows the system according to the present invention, together with the connected components, in a block diagram. An airbag control unit ABSG as system according to the present invention has an evaluation circuit taking the form of microcontroller μC, which processes sensor signals and, as a function thereof, controls a trigger circuit FLIC in such a way that the trigger circuit controls passenger-protection means PS, such as airbags or seat-belt pretensioners, as a function of the sensor signals. Moreover, evaluation circuit μC has the possibility of transmitting control signals to a further control unit ESPSG, thus, to the vehicle dynamics control, via interface IF3, so that, as a function of this control signal, the vehicle dynamics control controls the steering angle LW or a brake system ABS or an electronic stability program ESP according to this control signal.

The sensor signals are first of all made available via interface IF2 in control unit ABSG, and secondly, directly by sensor suite ESP-S. Sensor suite ESP-S is what is known as an ESP electronic stability program sensor suite, which normally is disposed in an ESP-control unit. For example, this sensor suite supplies yaw rate ωz, accelerations in the spatial directions, but for low accelerations, the roll rate ωx as well as the pitch rate ωy. Low acceleration means below 3 g, for example, and is therefore to be distinguished from the acceleration sensors for the airbag control unit, which detect accelerations of up to 30 g, for instance. As indicated above, this sensor suite is disposed in airbag control unit ABSG in order to permit a high sampling rate of these sensor values, so that these signals may be taken into account as quickly as possible. It is feasible to merge airbag control unit ABSG and electronic-stability-program control unit ESPSG to form one control unit.

Interfaces IF2, IF3 as well as trigger circuit FLIC may be combined in one system ASIC in control unit ABSG, that is, on at least one integrated circuit. Further functions of control unit ABSG may also be present on this system ASIC like, for example, the energy supply, which also relates to the firing current for trigger circuit FLIC. Interfaces IF2 and IF3 may also be designed as software.

Further components which are necessary for the operation of control unit ABSG have been omitted for the sake of simplicity. In the case of control unit ESPSG, the components have been omitted completely; required for the function in the present case are interfaces, as well as a processor which makes the decision for the control as a function of the control signal. The sensor signals of sensor suite ESP-S may also be transmitted from airbag control unit ABSG to operating-dynamics control unit ESPSG in order to be processed there.

Airbag control unit ABSG may have further sensors in its housing, such as acceleration sensors for sensing a crash. In the present case, however, these sensors are disposed in what is called a sensor control unit DCU, and specifically, rotation-rate sensors D, acceleration sensors A and structure-borne-noise sensors, and their signals are transmitted via interface IF1 to interface IF2 in airbag control unit ABSG. The advantage of this splitting into a sensor control unit is that the airbag control unit is able to be positioned more freely. For example, sensor control unit DCU may then be disposed on the vehicle tunnel, and is able to make its measured sensor values available to other control units, as well. As a rule, the sensors are produced micromechanically; preprocessing of the sensor signals, e.g., filtering, integration, etc., may also be provided in sensor control unit DCU. For instance, a current interface may be used as interface, the data being modulated upon a no-load current, e.g., in a Manchester coding.

FIG. 2 shows a typical accident situation. Vehicle FZ collides in front on side KO with obstacle H1. This induces a moment of rotation, i.e., a yaw acceleration in direction GW. The direction of travel is denoted by X. This moment of rotation involves the risk that vehicle FZ is rotating in such a way that it may collide against at least one of obstacles H2 and H3 in a consequential collision. As a further consequence, another collision may then again take place with obstacle H1.

The aim of the present invention is now for the collision with obstacle H1, which may represent a non-triggering crash, to supply sensor data in order to prepare for the consequential collisions. The yaw acceleration in particular is a suitable sensor signal for this purpose.

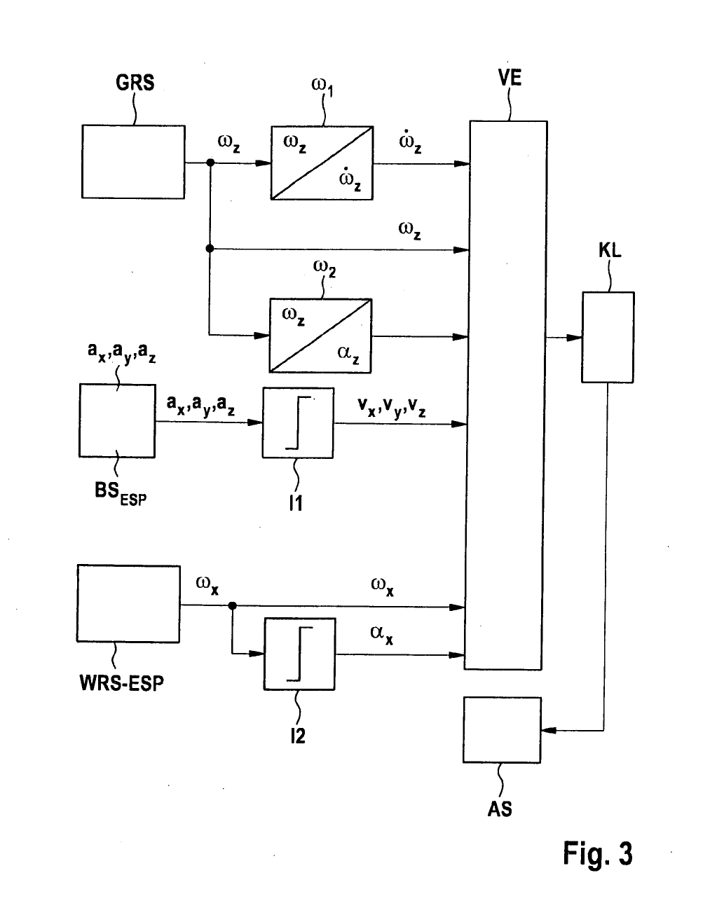

FIG. 3 is a signal-course diagram showing how various sensor signals are combined to form a vector which is then classified and leads to the control signal. Yaw-rate sensor suite GRS generates signal ωz. Signal ωz is differentiated in first converter W1, in order to generate yaw acceleration \dot{ω}z. As indicated above, to that end, a minimum variance estimator may be used for the derivation with respect to time. This yaw acceleration \dot{ω}z then goes into vector generator VE. Yaw rate ωz itself may likewise be entered into the vector generator. Moreover, it is possible that in a second converter W2, yaw rate ωz is converted by integration or totaling to form yaw angle αz, which is likewise entered into vector VE. Further signals, like acceleration signals ax and ay or az, which are generated by acceleration sensor suite BSESP, are integrated in integrator I1 to form speeds vx, vy, vz, and go into vector VE, as well. Furthermore, from a roll-rate sensor suite WRS-ESP, roll rate ωx, as well as the integrated roll rate, i.e., roll-rate angle αx may be entered into vector VE. More or fewer than the components presented may go into vector VE. It is also possible for the pitch rate and variables derived from it to be taken into account appropriately.

This vector VE is classified in classification KL. The classification algorithms indicated above are usable for this purpose. With the classification, control signal AS may then be determined. This may then be used to control passive passenger-protection means PS, or the control signal may be transmitted to the vehicle dynamics control, so that interventions are carried out in the vehicle in order to stabilize this vehicle.

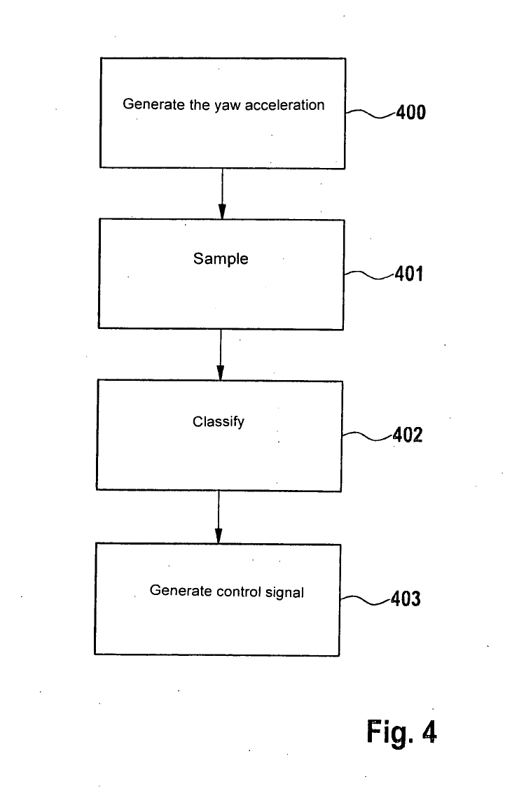

FIG. 4 is a flow chart showing how the method according to the present invention proceeds. In method step 400, the yaw acceleration is generated in the manner indicated above. That is to say, the analog sensor signal is differentiated in analog fashion, in order to obtain the yaw acceleration. For example, such an analog differentiation is realized by operational-amplifier circuits having resistors and capacitors familiar to one skilled in the art. In method step 401, this yaw acceleration is sampled. It is possible that first of all, the sensor signal is sampled, and then the yaw acceleration is determined digitally with the aid of an RLS—or other digital differentiator.

In method step 402, the classification is carried out as described for FIG. 3. In method step 403, the control signal is then generated and further processed in the suitable manner, either for controlling the passive passenger-protection means, or for controlling active passenger-protection means, both of which are combined as safety means. The control signal may also be used in a control algorithm in order to influence thresholds, for instance, to switch functions of the algorithm on or off or to serve as a plausibility check.

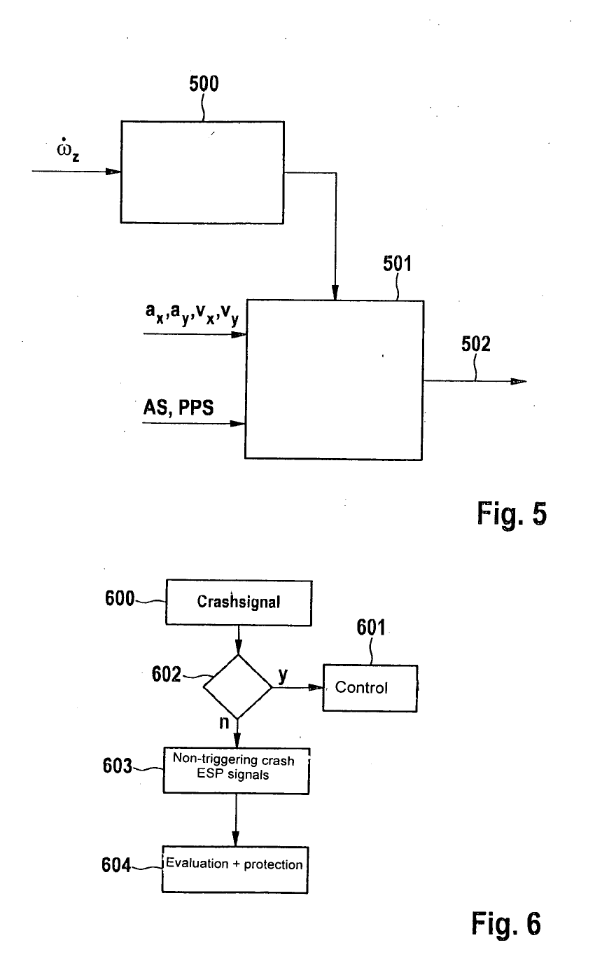

FIG. 5 shows such a practical application in a further signal-course diagram. Yaw acceleration \dot{ω}z goes into block 500 in order to determine, based on the yaw acceleration and possibly further sensor signals, whether control algorithm 501 must be influenced, and if yes, how. This may be done, for instance, by influencing at least one threshold value in algorithm 501, or perhaps as a plausibility decision or as the switching on and off of functions. The control algorithm itself processes the crash signals, e.g., acceleration ax, ay or their integrated values vx, vy or the integrated values of vx, vy, namely, the forward displacements. Signals from remote acceleration sensors PAS and PPS or perhaps from a structure-borne-noise sensor suite may also be processed in control algorithm 501 in order to form control signal 502. In the present case, the control algorithm may be two-dimensional; for example, the forward displacement and the reduction of velocity are analyzed together in one diagram.

FIG. 6 shows a further application of the method according to the present invention. In method step 600, the crash signal—e.g., the acceleration signals—is obtained. In method step 602, based on the crash signal, it is decided whether it is a triggering crash or a non-triggering crash. If it is a triggering crash, then in method step 601, the passenger-protection means are controlled. If it is a non-triggering crash, then in method step 603, the ESP signals which are generated in the airbag control unit by a sensor suite are evaluated. In this instance, the yaw acceleration is used. In method step 604, the driving situation is evaluated in light of the yaw acceleration, and suitable protective measures are initiated. They include vehicle-stabilizing measures, for instance, or perhaps preventive protective measures to optimally protect the vehicle passengers in the event of consequential crashes.

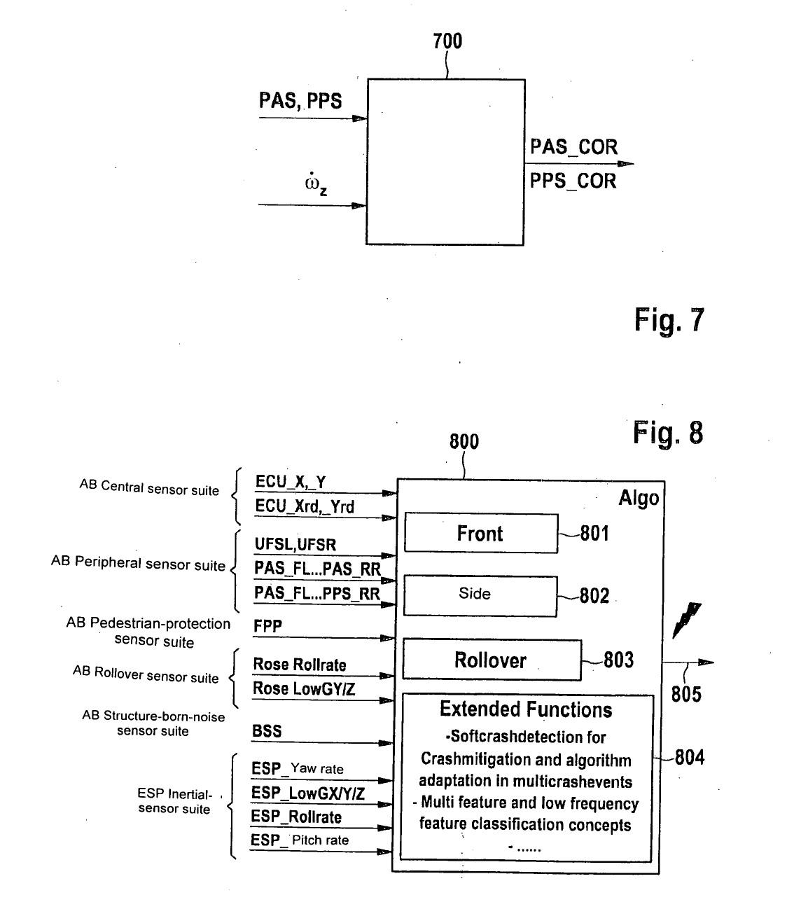

FIG. 7 shows a further signal-course diagram for the method of the present invention. In this instance, the signals from remote acceleration sensors PAS and air-pressure sensors PPS for detecting side collisions are corrected in block 700 as a function of yaw acceleration \dot{ω}z, so that signals PAS_COR and PPS_COR are available. The rotational movement induces signal portions in the linear acceleration sensors, which are able to be calculated out again with the aid of the rotational acceleration. This correction prevents measured values of the acceleration sensors which are possibly too low from taking effect negatively in a threshold-value comparison. Therefore, a compensation based on yaw acceleration is advantageous.

FIG. 8 is a signal-course diagram showing which sensor signals go into a control algorithm, for example. A central sensor suite in terms of acceleration ECUX and ECUY, respectively, and ECU_XRD and YRD, respectively, is used for the crash sensing. ECU_XRD and ECU-YRD denote acceleration sensors which are sensitive in the opposite directions with respect to ECUX and ECUY. These sensors are usually used to check plausibility.

Upfront sensors UFSL, UFSR, side sensors PAS_FL, PAS_RR and air-pressure sensors PPS_FL, PPS_RR, respectively, are used as peripheral sensor suite. These sensor signals may also be present repeatedly. In the same way, signals from pedestrian-protection sensor suite are used. In addition, signals from a rollover sensing are used, namely, the roll rate, or the signals of acceleration sensors which are designed for low accelerations, and specifically, in the transverse vehicle direction, and the vertical vehicle direction. The signals from a structure-borne-noise sensor suite BSS may also be entered into the algorithm. According to the present invention, the signals from the ESP-inertial sensor suite, namely, the ESP_yaw rate, the ESP_GX/Y/Z, the ESP_roll rate as well as ESP_pitch rate ωy are used. Further sensor signals may be used. It is clear to one skilled in the art that this represents only a selection, that more or fewer such sensor signals may be used, depending upon the type of vehicle and its features.

Algorithm 800, which, for example, runs on the microcontroller in the airbag control unit, features several of the software modules presented. These include a front crash module 801, which deals with front crashes. Also included is a side crash module 802, which deals with side crashes. A rollover module 803 is also provided. For it, one skilled in the art utilizes the methods known from the related art.

Another software module 804 features further functions such as a soft crash detection, which was described according to the present invention. For instance, soft crashes are non-triggering crashes, thus those which are not included under front side, rollover or, for instance, rear collision, as well. Furthermore, according to the present invention, a plurality of features, namely, at least three, are used for the classification, as well as features at low frequencies, e.g., up to 200 Hz. The control signal for the suitable passenger-protection means is generated at output 805. As indicated above, the algorithm may have further modules, especially for the control of active passenger-protection means, as well.

1-10. (canceled)

11. A method for controlling a safety arrangement for a vehicle, comprising:
generating at least one yaw-acceleration signal for the vehicle with the aid of a sensor suite;
sampling the at least one yaw-acceleration signal with a sampling time of less than 10 ms; and
generating a control signal for the safety arrangement as a function of the at least one yaw-acceleration signal.

12. The method as recited in claim 11, wherein a communication interface for transmitting and receiving data is provided for the output of the control signal.

13. The method as recited in claim 11, wherein the control signal is used by a control unit as one of a plausibility check or a threshold-value influence.

14. The method as recited in claim 11, wherein at least one signal derived from the at least one yaw-acceleration signal is entered into a three-dimensional vector, and the control signal is generated as a function of a classification of the three-dimensional vector.

15. The method as recited in claim 11, further comprising:
generating at least one further sensor signal;
recognizing, as a function of the at least one yaw-acceleration signal and the at least one further sensor signal, a crash event not requiring triggering of the safety arrangement;
evaluating the crash event not requiring triggering of the safety arrangement; and
controlling the safety arrangement as a function of the evaluation to protect against at least one subsequent crash event likely to result as a consequence of the crash event not requiring triggering of the safety arrangement.

16. The method as recited in claim 15, wherein a yaw angle is used as the at least one further sensor signal.

17. The method as recited in claim 15, wherein the at least one further sensor signal is evaluated as a function of the control signal.

18. The method as recited in claim 11, wherein the at least one yaw-acceleration signal is generated in such a way that the at least one yaw-acceleration signal is determined with the aid of a minimum variance method.

19. A system for controlling a safety arrangement for a vehicle, comprising:
a sensor suite configured to generate at least one yaw-acceleration signal for the vehicle; and
an evaluation circuit configured to (i) sample the at least one yaw-acceleration signal with a sampling time of less than 10 ms, and (ii) generate a control signal as a function of the at least one yaw-acceleration signal.

20. The system as recited in claim 19, wherein the sensor suite is incorporated in a control unit having the evaluation circuit.
